(19) United States
(12) Patent Application Publication
(10) Pub. No.: US 2020/0183334 A1
(43) Pub. Date: Jun. 11, 2020

(54) FIXING DEVICE FOR A BRACELET

(71) Applicant: Montres Breguet S.A., L'Abbaye (CH)

(72) Inventor: Fabrice ROCHAT, Vallorbe (CH)

(73) Assignee: Montres Breguet S.A., L'Abbaye (CH)

(21) Appl. No.: 16/642,225

(22) PCT Filed: Aug. 8, 2018
(86) PCT No.: PCT/EP2018/071553

§ 371 Date: Feb. 26, 2020

(30) Foreign Application Priority Data
Oct. 20, 2017 (EP) 17197553.5

(51) Int. Cl. G04B 37/14; A44C 5/14

(52) U.S. Cl. CPC G04B 37/1493; A44C 5/14

(57) ABSTRACT

A device for fixing a bracelet to a watch case includes at least one horn and a bracelet strand. The horn and the bracelet are held together by a bar. The horn includes a rigid blade arranged to fit together with at least one recess made in the bracelet strand. The at least one recess has an opening for receiving the blade during the placement of the bracelet strand so as to form a rigid link once the bar is put in place.

### FIELD OF THE INVENTION

The present invention relates to the field of horology or of jewelry. It more specifically relates to a device for fixing a bracelet to an object, in particular a watch case.

### BACKGROUND OF THE INVENTION

In general, bracelets, made of leather or metal, are fixed to the horns of a watch case, by way of a bar formed by a tube, in which two pistons capable of moving in translation are mounted, as well as an elastic member disposed between said pistons and tending to drive them outwards towards the exterior of the tube. Said bar is mounted inside a recess provided for this purpose at one end of the bracelet, and the pistons are engaged inside blind bores made facing one another in the horns of the case.

The placement and removal of a bracelet using this fixing mode requires the use of tools in order to retract and hold the piston. Such an operation requires a degree of dexterity. Moreover, when the bar is successfully inserted between the horns, the hole made in the horns must be located in order to allow the spring to insert this pin therein.

Such fixing modes do not allow for proper integration of the bracelet with the middle part, with gaps or defects that may be visible at the junction.

Moreover, these fixing modes provide the bracelet with too much freedom of movement once attached to the watch, which can be detrimental to the proper holding of the watch on the wrist of the wearer according to the morphology thereof.

### SUMMARY OF THE INVENTION

The present invention overcomes these drawbacks by proposing a device for fixing a bracelet to a watch case, the device comprising, on the one hand at least one horn, and on the other hand a bracelet strand, the horn and the bracelet being held together by means of a bar.

According to the invention, the horn comprises a rigid blade arranged to fit together with at least one recess made in the bracelet strand, said at least one recess having an opening for receiving said blade during the placement of the bracelet strand so as to form a rigid link once the bar is put in place.

According to other advantageous alternative embodiments of the invention:
the bracelet strand comprises a rigid insert, said insert comprising the recess for receiving said blade;
the blade is inclined downwards by an angle that lies in the range 20° to 45° relative to the median plane M of the watch case;
the width of the blade is less than or equal to the width of the median horn;
the horn comprises a banking element defining the hooking position of the bracelet strand with the watch case;
the means for fixing the bracelet strand comprise a bar,
the bracelet strand is made of a flexible plastics material and the insert is made of a hard material selected from the group consisting of metal materials or metal alloys, ceramics, or composite materials.

### BRIEF DESCRIPTION OF THE DRAWINGS

Other characteristics and advantages of this invention will more clearly emerge upon reading the following detailed description of one example embodiment of a fixing device for a bracelet according to the invention, said example being provided for the purposes of illustration only and not intended to limit the scope of the invention, given with reference to the accompanying drawing, wherein:

FIGS. 1a and 1b respectively show perspective views of a watch case equipped with a fixing device according to the invention;

FIGS. 2a and 2b show the same watch case, from a sectional view, respectively before and after fixing the bracelet thereof.

### DETAILED DESCRIPTION OF THE PREFERRED EMBODIMENTS

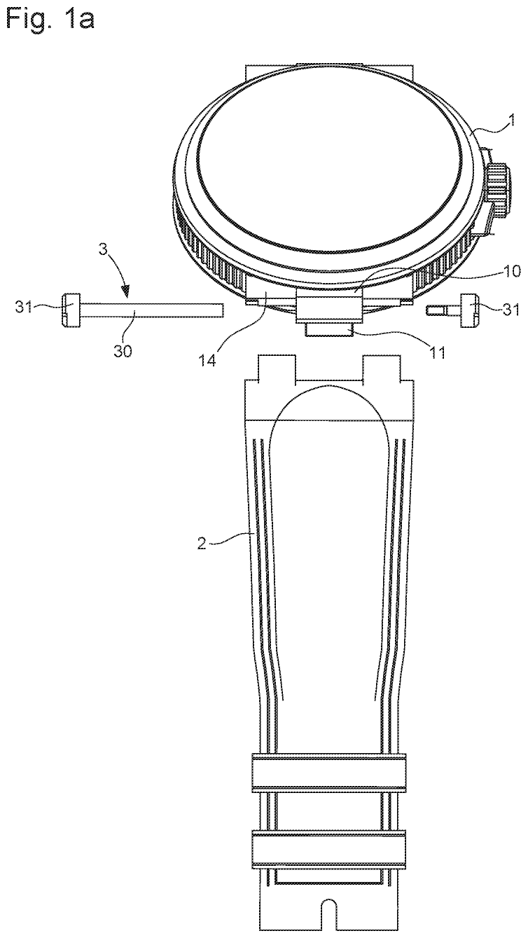

FIG. 1 shows a watch case 1, to which at least one end of a bracelet strand 2 is intended to be connected in a removable manner.

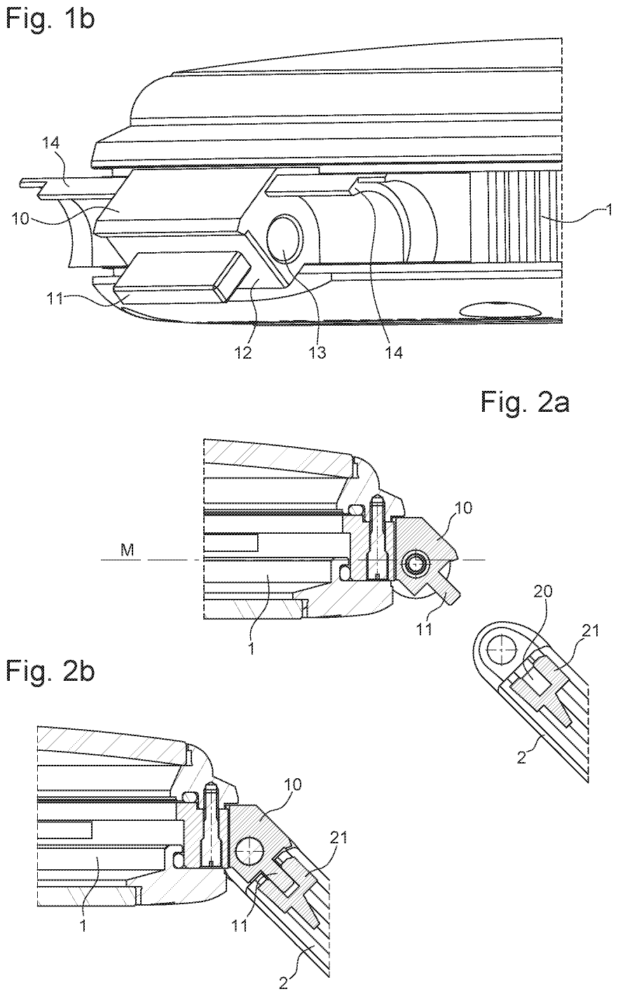

The linking device that is the subject of the invention is shown in FIGS. 1b, 2a and 2b. The device comprises, on the one hand, at least one horn 10, and on the other hand a bracelet strand 2, the horn 10 and the bracelet 2 being held together by means of a bar 3.

The horn 10 comprises a rigid blade 11 arranged to fit together with at least one recess 20 made in the bracelet strand, the recess 20 having an opening for receiving the blade during the placement of the bracelet strand so as to form a rigid link once the bar 3 is put in place.

In order to limit the travel of the blade 11, the horn 10 includes a flat surface 12 acting as a banking, the bracelet strand being pressed against this surface when the blade 11 is inserted into the bracelet 2, the flat surface 12 thus defining the hooking position of the bracelet strand with the watch case.

The horn 10 further comprises lateral shoulders 14, adjacent to the horn, and intended to partially cover the edges of the bracelet strand, thus preventing any gap from being visible at the link with the bar 3.

As shown in FIG. 1, the median horn comprises a passage 13, the diameter whereof corresponds to the diameter of the axis of the bar 3 such that it is free to rotate inside the passage.

The bar 3 is formed by a cylindrical rod 30 having a flange 31 at each of the ends of the bar, the bar 3 and the flanges 31 thus forming a single element once assembled together. The flange 31 could be assembled at the end of the bar 4 by way of an insertion point mounted in a hollow part of the bar 3. An inner bulge is thus made at the end of the bar 3 in order to engage with the insertion point, so as to clip the flange inside the bar. Other modes for fixing the flanges 31 can be considered, such as bonding, welding or even driving in, for example. The latter act as axial retaining elements for the bracelet.

Advantageously, the flanges 31 of the bar 3 are housed at the lateral shoulders such that the flanges are not projecting once the bar 3 has been mounted.

According to the invention, the bracelet strand 2 comprises a rigid insert 21, the insert comprising the recess 20 for receiving the blade 11 of the horn 10, the two elements forming a rigid link once the bracelet strand has been assembled with the case.

As shown in FIGS. 2a and 2b, the blade 11 is inclined downwards by an angle that lies in the range 20° to 45° relative to the median plane M of the watch case, such an inclination being necessary for the strand to be correctly positioned once the watch has been placed on the wrist.

The width of the blade is provided such that it is less than or equal to the width of the median horn, and comprises a length that is substantially identical to the depth of the recess 20 of the insert 21 so as to prevent any clearance after assembly.

According to the preferred embodiment shown in FIG. 1, the insert 21 and the blade 11 are made of a hard material selected from the group consisting of metal materials or metal alloys, ceramics or composite materials. The bracelet can be made of a flexible plastics material, or of a hard material mentioned hereinabove. A person skilled in the art will not encounter any particular difficulties in machining a recess 20 in a metal link, for example.

In order to fix the bracelet 2 to the case 1 as shown in FIG. 2b, the end of one strand is inserted, at the horn 10, by bringing the opening of the recess 20 to face the blade 11 in order to house the blade 4 inside the insert 21 of the bracelet strand.

Once the blade 11 has been partially positioned inside the insert 21, the user pushes the strand 2 until it abuts against the flat surface 12 of the horn 10.

The user then must simply place the bar 3 by successively passing it through the strand 2 and the horn 10 until the flanges 31 are positioned in abutment against the edges of the strand 2 and beneath the shoulders 14 adjacent to the horn 10.

In this manner, the carrier has a bracelet with no clearance once assembled and that is properly held in place when the watch is being worn.

In the aforementioned embodiment, the insert is disposed on a bracelet made of leather, synthetic fabric, plastic, metal, ceramic or even composite material. Similarly, the bar 4 is preferably made of metal but also could be made of plastic, ceramic or even composite material.

According to another embodiment, the rigid blade 11 and the recess 20 are inverted. The bracelet strand 2 comprises a rigid blade 11 arranged to fit together with at least one recess 20 made in the horn 10, said at least one recess 20 having an opening for receiving said blade 11 during the placement of the bracelet strand so as to form a rigid link once the fixing means are put in place.

It goes without saying that the present invention is not limited to the example shown and that various alternatives and modifications that may be apparent to a person skilled in the art can be made thereto.

1-8. (canceled)

9. A device for fixing a bracelet to a watch case, the device comprising:
at least one horn and a bracelet strand, the horn and the bracelet strand being held together by a bar, the horn comprising a rigid blade arranged to fit together with at least one recess made in the bracelet strand, said at least one recess having an opening for receiving said blade during the placement of the bracelet strand so as to form a rigid link, the horn comprising a passage through which said bar passes in order to hold the bracelet strand on the watch case,
wherein the bracelet strand comprises a rigid insert, said insert comprising said recess for receiving said blade.

10. The fixing device according to claim 9, wherein said blade is inclined downwards by an angle that lies in the range 20° to 45° relative to the median plane M of the watch case.

11. The fixing device according to claim 9, wherein the width of the blade is less than or equal to the width of the median horn.

12. The fixing device according to claim 9, wherein the horn comprises a banking element defining the hooking position of the bracelet strand with the watch case.

13. The fixing device according to claim 9, wherein the bracelet strand is made of a flexible plastics material and the insert is made of a hard material selected from the group consisting of metal materials or metal alloys, ceramics, or composite materials.
